(19) United States
(12) Patent Application Publication
(10) Pub. No.: US 2026/0008265 A1
(43) Pub. Date: Jan. 8, 2026

(54) Anilox Roller, Printing Unit with Anilox Roller and Method for Producing an Anilox Roller

(71) Applicant: Matthews International GmbH, Vreden (DE)

(72) Inventors: Thomas HACKFORT, Ahaus-Alstätte (DE); Christof RÖRING, Ahaus (DE)

(21) Appl. No.: 19/256,425

(22) Filed: Jul. 1, 2025

(30) Foreign Application Priority Data
Jul. 4, 2024 (DE) 10 2024 119 062.0

(51) Int. Cl. B41F 31/26; B23K 26/362; B41F 5/24; B41F 9/06; B41F 9/10; C09D 11/52; H01M 4/04

(52) U.S. Cl. CPC B41F 31/26; B23K 26/362; B41F 5/24; B41F 9/063; B41F 9/10; C09D 11/52; H01M 4/0409

(57) ABSTRACT

The invention relates to a screen roller, wherein at least one fluid coating material can be applied to the screen roller from at least one reservoir and the coating material can be transferred from the screen roller to at least one receiving element, wherein the surface of the outer jacket of the screen roller has a plurality of recesses for at least temporarily receiving the coating material, wherein furthermore at least two recesses are fluidically connected by means of at least one connecting channel formed in the surface and/or below the surface and/or the outer jacket, as well as to a printing unit and a method for producing a screen roller.

### CROSS-REFERENCE TO RELATED APPLICATIONS

The present application claims priority to German Patent Application No. 10 2024 119 062.0 filed Jul. 4, 2024, which is incorporated herein by reference in its entirety.

### DESCRIPTION

The present invention relates to a screen roller, in particular an anilox roller, for at least one printing unit, in particular an anilox and/or flexographic printing unit, and to a printing unit comprising at least one such screen roller.

Printing units of this type are known in particular from offset newspaper printing or in waterless offset printing for producing printed documents. Printing units of this type are also increasingly being used in the production processes of electrical storage devices such as batteries, accumulators, capacitors, electrolyzers and the like. Thus, these printing units enable continuous processing in comparison to the sequential or serial processing of individual elements. This increases throughput and production speed. Processing speeds of 300 m/min and more are desired. Components of the electrical storage device which can be produced starting from windable materials, such as films, optionally plastic and/or metal films, are coated by means of such printing units, for example with a precoating, such as for increasing the adhesive property and/or adhesion of further elements which are applied to the material. Such printing units also permit the application of high layer thicknesses in one coating step.

Owing to the use of the coated materials in electrical storage devices, these must meet extremely high quality requirements, in particular with regard to uniformity, layer thicknesses, accuracy of boundaries of coated surfaces, and/or impurities in regions not to be coated. In this way, in particular, higher quality requirements are imposed on the printing units in conjunction with the screen roller for use in this technical field in comparison with printing units used in the field of literature printing or color printing.

However, an intermittent coating is necessary in the production of the elements of the electric storage devices, as in the production of battery films. In such a coating process, the coating material is applied to a carrier material in places in the circumferential direction of a roll, wherein an uncoated region follows between each coated region.

Such a coating is very difficult to realize in a slot coating process, if at all, since it is a casting process and thus the edge smoothing cannot be controlled cleanly and tear-off edges are formed.

In contrast, the coating region can be selected very precisely in the anilox or gravure printing process.

Thus, in the case of slot coating, a continuous coating is indeed made possible, in which a thin coating material is applied to the carrier material through a narrow gap or a “slot” opening. However, as mentioned, the edge formation is not possible in the necessary quality.

In the gravure printing process, direct printing is carried out in which the coating material, in the case of printed literature products the ink, is transferred from a printing form formed by the recess in the screen roller to the substrate, which makes mass production possible. In addition, gravure printing offers the advantages of a high printing quality with high application rates, which are necessary for the production of elements of electrical storage devices, due to the high-volume screen geometry mentioned, for the coating material and a uniform distribution over large areas and enables the coating of precisely defined areas.

In particular, at the desired processing speeds of 300 m/min and more, effects not known from the field of the production of printed literature products occur, which lead to enormous and unacceptable quality losses. In particular, the combination of these processing speeds with a large-volume application, i.e. an application of volumes of, for example, 75-80 cm³/m² in the case of a wet application, which corresponds, for example, to a layer thickness of approximately 22.3 μm or an application weight of 60-70 g/m² of the coating material on the carrier material, poses further challenges.

The so-called pumping effect is to be emphasized here. Thus, when the coating material is applied to the screen roller, air is trapped in the coating material when it is applied to the screen roller from the reservoir, such as a doctor blade chamber. For example, high speeds of the printing unit and thus of the screen roller are necessary for the high processing speed. These lead to increased vibrations between the reservoir and the screen roller, which leads to uneven amounts of coating material applied to the screen roller.

Due to the high machine speeds and the large-volume application, minimal air is pressed into the individual recesses (cups) of the screen roller, in particular during the printing process in the printing unit at the reservoir. After the doctor blade process, this air expands instantaneously and escapes from the recess. This causes splashes and/or bubbles. These bubbles subsequently appear on the carrier material as an irregularity. In other words, foaming may occur.

Furthermore, due to this so-called pumping effect, when a doctor blade chamber is used, a vibration arises at the doctor blade, which increases or intensifies the spray effect, the bubble formation and the foam formation in the chamber doctor blade or the ink trough and can additionally generate vibrations which can damage the screen roller.

It is known in the prior art to add additives to the coating material. These can be foam prevention agents, i.e. substances which form a closed film, in particular at an interface of a fluid, which film accelerates outgassing or allows outgassing while destroying gas bubbles, in order to influence the properties of the coating material in the desired manner, in particular in order to be able to reduce the effects described above. However, the addition leads to a reduction in the processing speed or to an increased production effort. For example, the corresponding additives are to be removed from the printed product before further processing, for example by heat treatment.

There have also been attempts to avoid, at least reduce, this pumping effect or its effects by using special coatings on the screen roller, such as Teflon coatings. However, even these measures do not lead to the desired quality improvements.

It is therefore an object of the present invention to provide a screen roller and a printing unit which make possible the production of high-quality components of electrical storage devices, and in particular eliminates, or at least reduces, the pumping effect.

This object is achieved with respect to the screen roller by means of a screen roller, wherein at least one fluid coating material can be applied to the screen roller from at least one reservoir and the coating material can be transferred from the screen roller to at least one receiving element, wherein the surface of the outer jacket of the screen roller has a plurality of recesses for at least temporarily receiving the coating material, wherein furthermore at least two recesses are fluidically connected by means of at least one connecting channel formed in the surface and/or below the surface and/or the outer jacket.

In this connection, it is preferred that the coating material comprises at least one highly viscous battery material, at least one slurry coating material, at least one suspension, at least one, in particular chemical, active material, preferably a battery, and/or at least one highly viscous coating material, preferably for coatings in the HFC range.

It can also be provided that the reservoir comprises at least one doctor blade and/or at least one chamber doctor blade.

A screen roller can be characterized in that the receiving element comprises at least one further roller and/or at least one carrier material.

In this connection, it is particularly preferred that the carrier material comprises at least one windable material, at least one flexible material, at least one film, at least one component of an electric storage device, and/or at least one carrier material which can be used in a component of an electric storage device, wherein the electric storage device optionally comprises at least one battery, an accumulator, a capacitor, an electrolyzer, a wet cell, a flow battery and/or a redox flow battery and/or forms these at least in regions.

It is also proposed that at least one recess comprises at least one cup, at least one hashure, at least one pyramidal recess, at least one trough-shaped recess, at least one dome-shaped recess and/or at least one truncated pyramidal recess, and/or the recess has, at least in some regions, a rectangular, a square, a pentagonal, a triangular, a hexagonal, a circular, an octahedral and/or an elongated cross-section, in particular opening cross-section and/or bottom cross-section, and/or that a plurality of recesses form, at least in some regions, a uniform and/or geometric pattern, such as a “Penrose” grid.

Preferred embodiments provide that the screen roller can be rotated at least about an axis of rotation, wherein the recesses connected by the connecting channel are arranged offset at least in regions about the axis of rotation and/or the connecting channel has at least one directional component in the circular direction and/or circumferential direction of the axis of rotation.

Finally, it is proposed for the screen roller that the recess be produced by means of laser etching and/or direct laser removal.

With regard to the printing unit, this object is achieved by a printing unit comprising at least one screen roller according to the invention, in particular as described above.

For the printing unit, it is proposed that the printing unit comprises at least one reservoir for at least one fluid coating material, the reservoir optionally being operatively connected at least indirectly to the screen roller for transferring the coating material to the screen roller.

It is also preferred that at least one further roller is operatively connected to the screen roller, the screen roller and the further roller preferably rolling against one another.

Furthermore, it can be provided that at least one carrier material which can be coated and/or is to be coated with the coating material at least in regions can be fed to the screen roller and/or the further roller.

The invention further provides a method for producing a screen roller, in particular a screen roller according to the invention, preferably as described above, wherein the method comprises providing a roller with a cylindrical surface and forming a screen of recesses on the surface of the roller, wherein the forming of the screen comprises (i) forming at least two recesses which are connected to one another by at least one connecting channel and/or (ii) forming the recesses by means of laser etching and/or direct laser removal.

The invention is therefore based on the surprising finding that, by forming a screen with recesses on a screen roller, in which the individual recesses, such as cups, are connected to one another, any entrapped air can escape from the respective recess into the recess connected by means of the connecting channel during the process of applying the coating material. Thus, the described pumping effect is minimized and also the vibration at the doctor blade is reduced. Furthermore, the screen geometry results in a better smooth position of the coating material on the carrier material. Preferably, the connected recesses are arranged at different circular positions in the circumferential direction of the screen roller, in particular in the machine direction of the gravure printing machine. This ensures that the air can escape from the connected recess without obstruction, in particular that the connected recess is not covered at all or is not completely covered, for example by the doctor blade and/or the coating material in the reservoir. The air can escape through the thus existing at least partially uncovered region.

At the same time, the arrangements of the recesses in the screen also produce a high degree of uniformity of the coating material on the receiving element, in particular on the carrier material. In particular, the foaming of the coating material which leads to irregularities is prevented, at least reduced.

Furthermore, due to the minimization of the air inclusions, a vibration of a doctor blade during the process is suppressed, at least reduced, and thus a more uniform application of the medium to the receiving element, such as the carrier material or a further roller, is ensured.

The recesses are preferably laser-etched or produced by direct laser removal in order to produce the screen structures in the screen roller, optionally for a gravure printing unit and/or anilox printing unit, the screen being formed by recessed and elevated elements.

With laser etched engraving, optionally with a hexagonal screen, a maximum theoretical drawing volume of 200 cm³/m² can be achieved, which leads to a wet application of 75-80 cm³/m² with a maximum emptying of the reservoir in the process of 40%. In contrast, in an electromechanical engraving, only a maximum theoretical drawing volume of 50 cm³/m² can be achieved, which leads to a wet application of a maximum of 19-20 cm³/m², which corresponds to a layer thickness of approximately 5.8 μm.

Further features and advantages of the invention will be apparent from the following description, in which preferred embodiments are explained based on the attached figures.

In particular

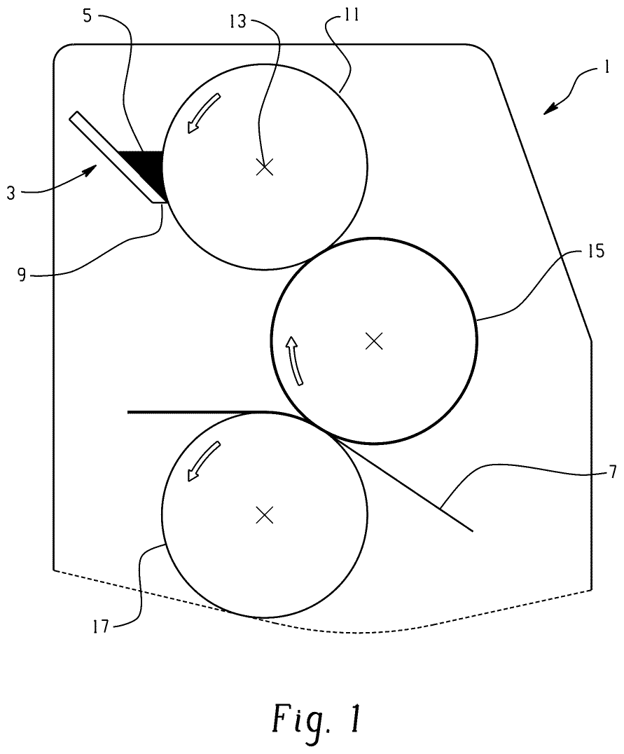

FIG. 1 shows a schematic representation of a printing unit according to the invention with a screen roller according to the invention;

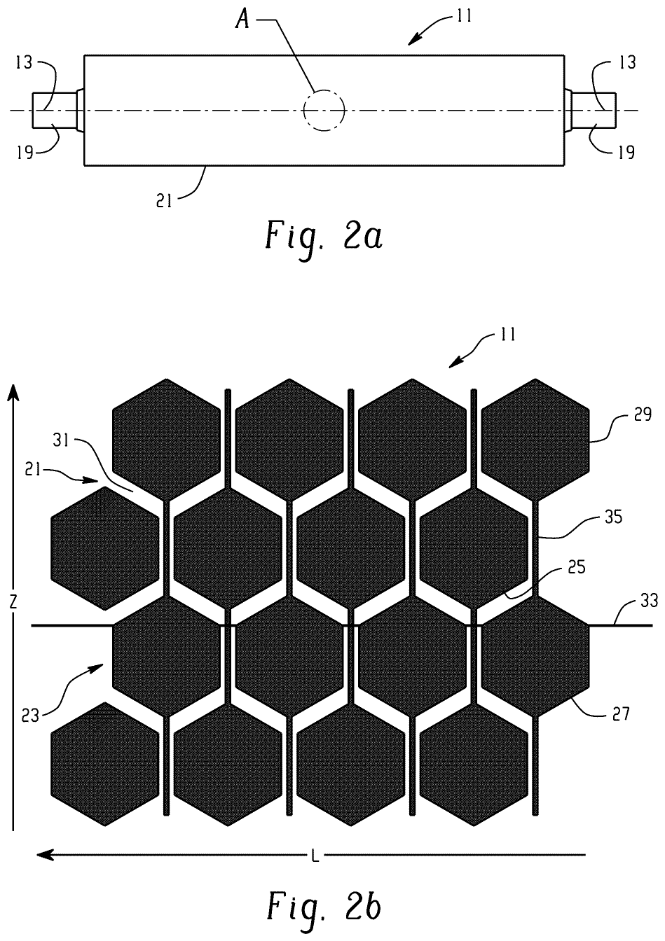

FIG. 2a shows a view of a first embodiment of a screen roller according to the invention;

FIG. 2b shows a detailed view of the cutout A of the screen roller of FIG. 2a;

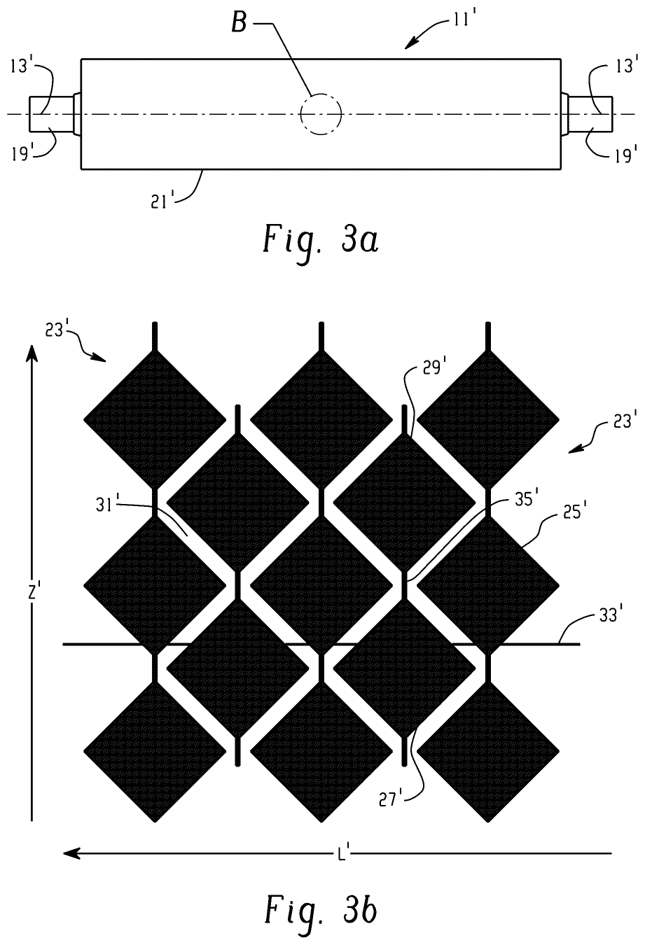

FIG. 3a shows a view of a second embodiment of a screen roller according to the invention;

FIG. 3b shows a detailed view of the cutout B of the screen roller of FIG. 3a; and

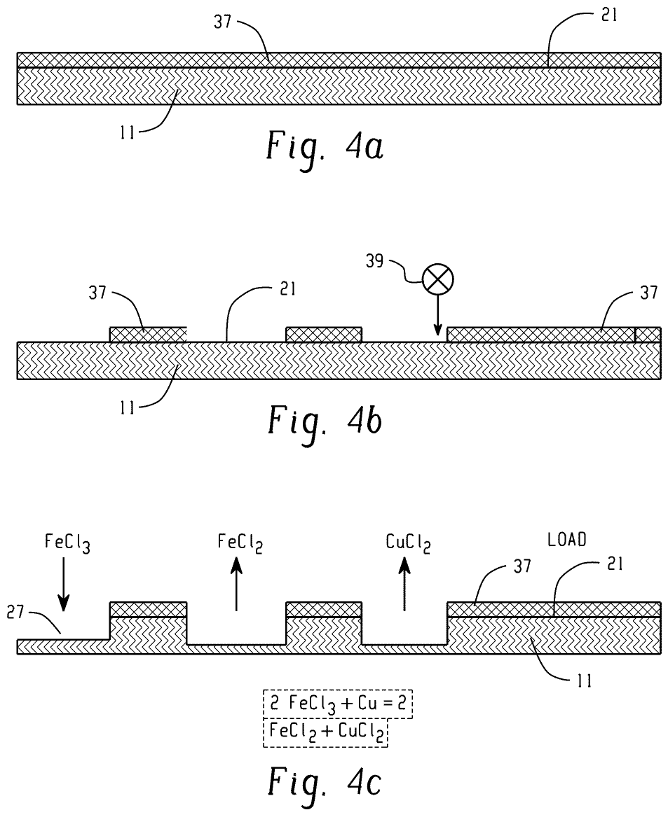

FIGS. 4a-4c show steps of a method for laser etching engraving for producing a grid on a screen roller according to the invention.

FIG. 1 shows the schematic construction of a printing unit 1 according to the invention. The printing unit 1 is constructed as a calender and comprises a reservoir 3 for receiving a coating material 5. In this example, the reservoir 3 is designed as a chamber doctor blade. As will be explained below, the printing unit 1 is used for coating a carrier material 7 for producing elements of an electric storage device. For this purpose, different coating materials such as glue, lacquer, primer or the like are used as required by means of the printing unit 1. Such coating materials have significantly different properties, such as viscosity, weight per unit area, pigment size, pigment concentration, composition, flow behavior and/or drying behavior, compared with printing ink, as used in printing units for printing paper.

In order to coat the carrier material 7, such as a plastic film or metal film, such as copper film, the coating material 5 is transferred to a screen roller 11 according to the invention by means of the chamber doctor blade 3, in particular a doctor blade 9 enclosed by the reservoir 3.

As a result of the rotation of the screen roller 11 about the axis of rotation 13, the coating material 5 is transferred to a receiving element, here in the form of a transfer roller 15 which rotates in the opposite direction or in the same direction as the screen roller 11. The coating material 3 is then applied to the carrier material 7. This carrier material passes through a gap between the transfer roller 15 and a pressure roller 17.

In order to fix the regions of the carrier material 7 to which the coating material 5 is applied, the screen roller 11 has a grid 23 on its surface. This grid 23 comprises recesses or cups in which the coating material is received. These recesses are thus arranged in the regions in which the coating material 5 is to be applied to the carrier material 7, while the regions of the screen roller 11 which do not have a recess remain free of coating material, so that corresponding regions of the carrier material 7 remain free of the coating material 5. In particular, any coating material 5 adhering to these regions is stripped off by the doctor blade 9.

In the production of elements for electrical storage devices, as already mentioned, coating materials 3 having greatly different properties compared to printing inks are used. These have an increased tendency to form air inclusions and foam during the transfer of the coating material 3 to the screen roller. This pumping effect already described in the introduction leads to considerable problems and significantly limits throughput rates and production speed.

In order to overcome, at least reduce, the pumping effect, the invention proposes a special type of grid on the screen roller 11. Furthermore, this grid is preferably produced by means of laser etching engraving in order to further increase the quality of the coating on the carrier material.

FIG. 2a shows a side view of a screen roller 11 according to the invention. The screen roller 11 is mounted rotatably about the axis of rotation 13 via bearings 19.

FIG. 2b shows a detailed view of the cutout A of the screen roller 11 according to a first embodiment. FIG. 2b shows the outer jacket of the screen roller 11 in the cutout A. As can be seen from FIG. 2b, the surface 21 of the screen roller 11 has a grid 23. This grid 23 is formed by recesses 25, 27, 29. In this embodiment, the recesses 25, 27, 29 have a hexagonal opening cross-section. Elevations in the form of webs 31 are formed between the recesses 25, 27, 29, the surface of which webs lies at the level of the remaining surface 21 of the screen roller 11, in which no recesses are formed.

FIG. 2a also shows the screen roller 11 in a position in which the doctor blade 9 rests in position 33 on the surface 21 of the screen roller 11.

According to the invention, the grid 23 is characterized in that connecting channels 35 are formed between individual recesses. By way of example, reference is made to the connecting channel 35 between the recesses 27 and 29. The connecting channel 35 extends substantially along or parallel to a circumferential direction Z and perpendicular to a longitudinal direction L of the screen roller 11. The longitudinal direction L extends parallel to the axis of rotation 13.

In embodiments not shown, the connecting channel can also extend in another direction relative to the longitudinal direction L and the circumferential direction Z. However, it is preferred, as explained below, that the connecting channel has a directional component along the circumferential direction Z.

As can be seen from FIG. 2b, the recess 27 is arranged in the region of the position 33. In other words, the recess 27 is filled with coating material 5 or lies in the region of the reservoir 3, so that the opening cross-section is covered with coating material 5. Any air contained in the coating material 5 which is located in the recess 27 cannot therefore leave the recess 27 through the opening cross-section of the recess 27.

However, the recess 29 as well as the connecting channel 35 or the respective opening cross section is open to the environment or is not covered by the doctor blade chamber 3 or coating material 5. As a result, the air enclosed in the recess 27 can escape through the connecting channel 35 or the recess 29.

As a result, the pumping effect can be suppressed or at least reduced in comparison with the grids known from the prior art. This makes it possible to realize higher processing speeds or throughput rates without a loss of quality.

FIGS. 3a and 3b show a further, alternative embodiment of a screen roller 11′. Those elements of the screen roller 11′ which correspond to those of the screen roller 11 bear the same reference numerals, but are simply provided with an index.

The screen roller 11′ differs from the screen roller 11 in particular in that an alternative shape of the opening cross-section of the recesses 25′, 27′, 29′ is realized. The opening cross-sections are rectangular or square, as can be seen in FIG. 3b, which shows a detailed view of the screen roller 11′ of FIG. 3a in cutout B. This makes it possible for the recess to be adapted to the respective coating material 5, in particular its properties, such as viscosity, flowability and the like, in particular in order to further reduce the pumping effect and/or to permit higher throughput rates without pumping effect, at least without increasing the pumping effect.

The connecting channels 35, 35′ are dimensioned such that air inclusions can escape from the recesses 27, 27′ through the connecting channels 35, 35′ and/or the recesses 29, 29′, while the coating material 5, 5′ remains in the recesses 27, 27′.

The inventors have also recognized that an alternative or additional measure for reducing the pumping effect consists in that the grid in the screen roller, in particular the grids 23, 23′ in the screen rollers 11, 11′, is produced by means of laser etching engraving.

FIGS. 4a to 4c outline the steps of such a production of a recess.

In a first step, the surface 21 of the screen roller 11 is coated with a masking coating 37, in particular over its entire surface. In the present example, the screen roller 11 comprises a copper material.

According to FIG. 4b, the masking coating 37 is partially removed by means of a laser 39, for example an Nd-YAG laser. This takes place at the positions at which the respective recesses are to be produced.

In a subsequent etching step, as shown in FIG. 4c, an etching is carried out on the regions freed from the masking coating 37. FeCl3, for example, can be used here. This is converted into FeCl2 and CuCl2 on the copper surface of the screen roller 11, as a result of which copper is removed and the recess 27 is formed.

In a subsequent step, the remaining masking coating 37 is removed, but without further removal of the surface 21 of the screen roller 11.

The features described and disclosed in the above description, in the claims and in the figures, can be essential for the invention in its various embodiments both individually and in any combination.

### LIST OF REFERENCE NUMERALS

1 printing unit
3 reservoir
5 coating material
7 carrier material
9 doctor blade
11, 11′ screen roller
13, 13′ axis of rotation
15 transfer roller
17 pressure roller
19, 19′ bearing
21, 21′ surface
23, 23′ grid
25, 25′ recess
27, 27′ recess
29, 29′ recess
31, 31′ web
33, 33′ position
35, 35′ connecting channel
37 masking coating
39 laser
A, B cutout
L, L′ longitudinal direction
Z. Z′ circumferential direction

1. A screen roller, wherein at least one fluid coating material can be applied from at least one reservoir to the screen roller and the coating material can be transferred from the screen roller to at least one receiving element, wherein the surface of the outer jacket of the screen roller has a plurality of recesses for at least temporarily receiving the coating material, characterized in that at least two recesses are fluidically connected by means of at least one connecting channel formed in the surface and/or below the surface and/or the outer jacket.

2. The screen roller according to claim 1, characterized in that the coating material comprises at least one highly viscous battery material, at least one slurry coating material, at least one suspension, at least one, in particular chemical, active material, preferably a battery, and/or at least one highly viscous coating material, preferably for coatings in the HFC range.

3. The screen roller according to claim 1, characterized in that the reservoir comprises at least one doctor blade and/or at least one chamber doctor blade.

4. The screen roller according to claim 1, characterized in that the receiving element comprises at least one further roller and/or at least one carrier material.

5. The screen roller according to claim 4, characterized in that the carrier material comprises at least one windable material, at least one flexible material, at least one film, at least one component of an electric storage device, and/or at least one carrier material which can be used in a component of an electric storage device, wherein the electric storage device optionally comprises at least one battery, an accumulator, a capacitor, an electrolyzer, a wet cell, a flow battery and/or a redox flow battery and/or forms these at least in regions.

6. The screen roller according to claim 1, characterized in that at least one recess comprises at least one cup, at least one hashure, at least one pyramidal recess, at least one trough-shaped recess, at least one dome-shaped recess and/or at least one truncated pyramidal recess, and/or the recess has, at least in some regions, a rectangular, a square, a pentagonal, a triangular, a hexagonal, a circular, an octahedral and/or an elongated cross-section, in particular opening cross-section and/or bottom cross-section, and/or in that a plurality of recesses form, at least in some regions, a uniform and/or geometric pattern, such as a “Penrose” grid.

7. The screen roller according to claim 1, characterized in that the screen roller can be rotated at least about an axis of rotation, wherein the recesses connected by the connecting channel are arranged offset at least in regions about the axis of rotation and/or the connecting channel has at least one directional component in the circular direction and/or circumferential direction (Z) of the axis of rotation.

8. The screen roller according to claim 1, characterized in that the recess is produced by means of laser etching and/or direct laser removal.

9. A printing unit comprising at least one screen roller according to claim 1.

10. The printing unit according to claim 9, characterized in that the printing unit comprises at least one reservoir for at least one fluid coating material, wherein the reservoir is optionally operatively connected at least indirectly to the screen roller for transferring the coating material to the screen roller.

11. The printing unit according to claim 9, characterized by at least one further roller operatively connected to the screen roller, wherein the screen roller and the further roller preferably roll against one another.

12. The printing unit according to claim 11, characterized in that:
at least one carrier material which can be coated and/or is to be coated with the coating material at least in regions can be fed to the screen roller and/or to the further roller.

13. A method of manufacturing a screen roller, in particular according to claim 1, the method comprising:
providing a roller with a cylindrical surface; and
forming a grid of recesses on the surface of the roller,
wherein the formation of the grid:
(i) comprises the formation of at least two recesses which are interconnected by at least one connecting channel; and/or
(ii) the formation of the recess by means of laser etching and/or direct laser removal.
